(19) United States
(12) Patent Application Publication
(10) Pub. No.: US 2005/0004270 A1
(43) Pub. Date: Jan. 6, 2005

(54) Curable epoxy resin composition, fabrication process using the same and shaped articles obtained therefrom

(75) Inventors: Jens Rocks, Zurich (CH); Patrick Meier, Lenzburg (CH); Helmuth Leskosek, Monheim-Baumberg (DE); Oliver Claus, Ratingen (DE); Uwe Kaltenborn, Baden (CH)

Correspondence Address: CONNOLLY BOVE LODGE & HUTZ LLP, SUITE 800, 1990 M STREET NW, WASHINGTON, DC, 20036-3425, US

(73) Assignee: ABB T & D Technology Ltd., Zurich (CH)

(21) Appl. No.: 10/868,219

(22) Filed: Jun. 16, 2004

(30) Foreign Application Priority Data
Jun. 16, 2003 (EP) EP 03076850.1

(51) Int. Cl. B29C 45/00

(52) U.S. Cl. 523/400; 264/328.16; 264/331.11

(57) ABSTRACT

Curable epoxy resin composition comprising a polyepoxide; an anhydride hardener; a 1-substituted imidazole as catalyst; at least a diol in an amount of from 5 to 50 phr of said polyepoxide; a filler in an amount of from 200 to 600 phr of said polyepoxide and optionally additives. It shows improved crack resistance properties. An improved process for the fabrication of thermoset articles is also disclosed.

The present invention relates to a curable epoxy resin composition, a process for the fabrication of shaped articles using such composition and shaped articles thus obtained. Epoxy resins include a broad class of polymeric materials having a wide range of physical properties. The large spectrum of properties available with epoxy resins coupled with their formulating and processing versatility have made them particularly useful in electrical and electronic applications, such as insulating materials in the manufacture of transformers, switchgear, circuit breakers in medium and high voltage applications. Compared to other insulating materials, epoxy resins exhibit excellent mechanical and electrical properties, temperature and long-term creep stability, chemical resistance, and are more cost-effective. Epoxy resins are polyepoxide monomers or polymers containing generally two or more epoxide groups per molecule which are cured by reaction with curing agents to provide crosslinked or thermoset resins compositions with desired properties. Curing agents, also known as hardeners, are agents that may perform different functions, such as react covalently with the functional group(s) of the polyepoxide to propagate the crosslinking of the resin. Catalysts or accelerators are typically used to catalyze such reaction. Epoxy resins compositions typically contain fillers and may contain additives such as diluents, stabilizers and other ingredients. Curing of the epoxy resin is typically carried out at elevated temperatures (above 100° C.) and for an extended time, after the resin composition has been shaped into its final infusible three dimensional structure by a suitable fabrication process. Suitable fabrication processes include the Automatic Pressure Gelation (APG) Process and the Vacuum Casting Process. In the latter a solventless, liquid epoxy resin composition is poured into a mold and cured to a solid shaped article at elevated temperature and for a time of up to 10 hours. Afterwards the demolded part is usually postcured at elevated temperatures to complete the curing reaction and obtain a resin with the ultimate desired properties. Such a post-curing step may take, depending on the shape and size of the article, up to 30 hours.

The need for such an extended post-curing step represents a significant drawback in the production of such articles. Moreover, there is generally a need to improve the physical and mechanical properties of epoxy resins, particularly for electrical applications.

Many epoxy resin compositions and fabrication processes using the same are known from the prior art.

EP-A-0 604 089 discloses curable epoxy resin compositions including Bisphenol A, a saturated cycloaliphatic anhydride hardener, a polycarboxylic acid preferably derived from a polyol by in-situ reaction with the anhydride, a silica filler and quaternary ammonium or phosphonium salts as accelerators, for use in the APG Process. A post-curing step of the demolded casting for 2 hours at 135° C. in an air-circulatory oven appears to be required (page 6, line 9).

U.S. Pat. No. 4,931,528 discloses a curable epoxy resin consisting of diglycidyl ethers of Bisphenol A (DGEBA), without hardeners or other components, cured by certain substituted imidazoles at elevated temperatures such as 100-160° C. 1-isopropyl-2-methyl imidazole is preferred over 1-methyl imidazole and 2-ethyl-4-methyl imidazole. However, extended cure times (4-10 hours) at an elevated temperature (150° C.) are required to develop optimum physical properties (column 6, lines 1-2).

A first object of the invention is to provide curable epoxy resin compositions that generate cured resins with improved physical and mechanical properties.

A second object of the present invention is to provide a fabrication process capable of producing shaped thermoset articles made of cured resins with optimum or entirely satisfactory properties developed within relatively short times.

Another object of the present invention is to provide shaped thermoset articles, particularly for electrical applications, which possess suitable properties and are cost-effective.

These and other objects of the inventions are met by the curable epoxy resin composition, the fabrication process and the shaped articles set forth in the appended claims.

The curable epoxy resin composition according to the invention comprises:
a polyepoxide;
a anhydride hardener;
a 1-substituted imidazole as catalyst;
a diol;
a filler;
optionally additives or other ingredients.

Suitable polyepoxides are vicinal polyepoxy compounds with an average of at least 1.8 reactive 1,2-epoxy groups per molecule. They can be monomeric (degree of polymerization n=0) or polymeric (n>0, up to n=40 or more for high MW resins), saturated or unsaturated, aliphatic, cycloaliphatic, aromatic or heterocyclic, and may be substituted, if desired, with other substituents besides the epoxy groups, e.g. hydroxyl groups, ether groups, aromatic halogen atoms. Typically these materials have an epoxy equivalent weight of 100 to 250. Preferred polyepoxides are glycidyl ethers prepared by epoxidizing the corresponding allyl ethers or reacting, by known procedures, a molar excess of epihaloidrin such as epichloridrin with either a polyhydric phenol or a polyhydric alcohol.

An illustrative but not limiting list of dihydric phenols that can be reacted with an epihaloidrin include: 4,4′isopropylidene bisphenol; 2,4′-dihydroxydiphenylethylmethane; 3,3′-dihydroxydiphenyldiethylmethane; 3,4′-dihydroxydiphenylmethylpropylmethane; 2,3′-dihydroxydiphenylethylphenylmethane; 4,4′-dihydroxydiphenylpropylphenylmethane; 4,4′-dihydroxydiphenylbutylphenylmethane; 2,2′-dihydroxydiphenylditolylmethane; 4,4′-dihydroxydiphenyltolylmethylmethane: bis(4-hydroxyphenyl)methane. Other polyhydric phenols which may be reacted with an epihaloidrin to provide suitable polyepoxides include resorcinol, hydroquinone and substituted hydroquinones.

An illustrative but not limiting list of polyhydric alcohols that can be reacted with an epihaloidrin include: ethylene glycol; propylene glycols; butilene glycols; pentane diols; bis-(4-hydroxycyclohexyl)dimethylmethane; 1,4-dimethylolbenzene; glycerol; 1,2,6-hexanetriol; trimethylolpropane; mannitol; sorbitol; erythritol; pentaerythritol; their dimers, trimers and higher polymers; e.g. polyethylene glycols, polypropylene glycols; triglycerol; dipentaerythritol; polyallylalcohols; polyhydric thioethers such as 2,2′-3,3′-tetrahydroxydipropylsulfide; mercaptoalcohols such as monothioglycerol and dithioglycerol; polyhydric alcohols partial esters such as monostearin and pentaerythritol monoacetate; halogenated polyhydric alcohols such as monochlorohydrins of glycerol, sorbitol and pentaerythritol.

Preferred polyepoxides are those obtained by reacting epichloridrin with bisphenol A or with bisphenol F, such as the diglycidyl ether of bisphenol A (DGEBA) or of bisphenol F (DGEBF).

Suitable anhydride hardeners as curing agents include, but are not limited to: maleic anhydride; methyltetrahydrophtalic anhydride; methyl-4-endomethylene tetrahydrophtalic anhydride; hexahydrophtalic anhydride; tetrahydrophtalic anhydride; dodecenyl succinic anhydride. A preferred anhydride is methyltetrahydrophtalic anhydride. The stoichiometry of anydride hardeners may vary from a molar defect to a molar excess of the anhydride with respect to the polyepoxide, as it is known to those skilled in the art. When used to cure DGEBA, methyltetrahydrophtalic anhydride is typically present in an amount of from 40 to 70 parts per hundred (phr) of the DGEBA, preferably from 50 to 65 phr.

Suitable 1-substituted imidazole catalysts for the curing step are 1-alkyl imidazoles which may or may not be substituted also in position 2, such as 1-methyl imidazole or 1-isopropyl-2-methyl imidazole. According to one aspect of the present invention, it has been found that when such substituted imidazoles are used as catalysts for the curing step, the ultimate desired properties for the cured resins can be achieved in a relatively short time, without the need for an extended post-curing step. For DGEBA resins cured with anhydrides, a substituted imidazole catalyst is needed in amounts of no more than 5 phr of the DGEBA, preferably less than 2.5, more preferably less than 1 phr.

According to another aspect of the present invention, at least one diol is used as flexibilizer in the curable epoxy resin composition.

Suitable diols include aromatic diols such as bisphenol A and aliphatic monomeric or polymeric diols such as polyethylene glycols (PEG) or polypropylene glycols (PPG). According to another aspect of the invention, the presence of either an aromatic flexibilizer, e.g. bisphenol A, or an aliphatic flexibilizer, e.g. PEG, improves certain physical and mechanical properties of the cured resin, a synergistic effect been apparent when both the aromatic and aliphatic flexibilizers are present. According to the invention, the polyol is used in an amount of from 5 to 50 phr of the DGEBA, preferably from 10 to 45 phr. When both the aromatic and aliphatic diol are used, their weight ratio may vary from 80:20 to 20:80.

A wide range of fillers may be used, both fine and coarse particles. The filler may be inorganic such as china clay, calcined china clay, quartz flour, silica, cristobalite, chalk, mica powder, glass powder, glass beads, powdered glass fibre, aluminium oxide, wollastonite and magnesium hydroxide; or organic such as powdered PVC, polyamides, polyethylene, polyester or cured epoxy resins. Flame retardant fillers such as trihydrated alumina may also be used. In general, fillers with a particle size of from 0.1 to 3,000 μm may be used, preferably from 5 to 500 μm.

Filler loading in the composition can vary within a broad range, depending on the final application of the resin. High loading of inorganic fillers may improve certain properties such as abrasion resistance or electrical properties, usually at the expense of mechanical properties such as tensile and flexural strength. A right balance has to be found depending on the application. For electrical applications loading can be of from 200 to 600 parts per hundred (phr) of the polyepoxide, preferably of from 250 to 400 phr of the polyepoxide, more preferably from 300 to 400 phr.

The curable epoxy resin composition of the invention may contain other additives conventionally employed in molding resin compositions, such as pigments, dyes, stabilizers. Suitable fabrication processes for cured epoxy resin compositions of the invention are the APG Process and the Vacuum Casting Process. As mentioned above, such processes typically include a curing step in the mold for a time sufficient to shape the epoxy resin composition into its final infusible three dimensional structure, typically up to 10 hours, and an extended post-curing step of the demolded article at elevated temperature to develop the ultimate physical and mechanical properties of the cured epoxy resin composition. Such a post-curing step may take, depending on the shape and size of the article, up to 30 hours. Taking the Glass Transition Temperature (Tg) as an indicator of the desired ultimate properties of the cured resin, it is possible to define a relationship between the ultimate (Tgu) that would be developed by the resin if it were post-cured for an extended time of 10 hours, and a satisfactory Tg (Tgs) that is developed by the resin after 30 minutes of curing, directly after gelation, at a given temperature. This comparison allows to define a right balance between desired properties of the cured epoxy resin composition and acceptable duration (time) of the post-curing step to maximize the economics of the fabrication process. The improved fabrication process according to the invention comprises the steps of: a) pre-heating a curable liquid epoxy resin composition comprising a polyepoxide, an anhydride hardener, a 1-substituted imidazole catalyst and a filler; b) transferring such composition into a pre-heated mold; c) curing said composition at elevated temperature for a time-sufficient to obtain a shaped article with an infusible three dimensional structure and a satisfactory Tg (Tgs) which fulfils the relation 0.90·Tgu≦Tgs≦Tgu, preferably 0.94·Tgu≦Tgs≦Tgu, where Tgu is the Tg developed by the cured epoxy resin composition after a post curing step of 10 hours at 140° C.

The anhydride hardener is present in amount of from 40 to 125 phr of the polyepoxide, preferably from 50 to 90 phr of the polyepoxide. In a preferred improved fabrication process according to the invention the curable epoxy resin composition of step a) contain also one or more diols as flexibilizer.

In the examples below the invention is illustrated with reference to a Vacuum Casting Process, but they are not to be construed as to limiting the scope thereof in any manner.

### EXAMPLES

In the examples:
Glass Transition Temperature, Tg (° C.) was measured by the procedure according to ISO 11357-2.
Tensile Strength was measured by the procedure according to ISO 527.
Flexural properties were determined by the 3 points Bending Test to according ISO 178.
Fracture Toughness was measured by the procedure according to the Double-Torsion Test (Ciba-Standard; CG No.216-0/89), where K_{lc} designates the critical stress intensity factor and G_{lc} designates the critical energy release rate.

Four curable epoxy resin compositions according to the invention (examples 1 to 4) and one comparison composition according to the prior art (comparison example) were prepared as set forth in Table 1 below. The components of the composition are expressed in parts per hundred (phr).

TABLE 1

| Components | Comparison ex. | Ex. 1 | Ex. 2 | Ex. 3 | Ex. 4 |
|---|---|---|---|---|---|
| Diglycidylether of bisphenol A | 100 | 100 | 100 | 100 | 100 |
| (DGEBA) MW <700 (polyepoxide) | | | | | |
| Methyltetrahydrophtalic anhydride | 85 | 85 | 57 | 57 | 57 |
| (hardener) | | | | | |
| Benzyldimethylamine (catalyst) | 1.2 | | | | |
| 1-methylimidazole (catalyst) | | 0.75 | 0.75 | 0.75 | 0.75 |
| Bisphenol A (flexibilizer) | | | 14.2 | | 14.2 |
| Polyethylene glycol | | | | 14.2 | 20 |
| MW <400 (flexibilizer) | | | | | |
| Silica W12 (Quarzwerke Frechen, | 336 | 336 | 322 | 322 | 322 |
| Germany) (filler) | | | | | |

The components of each of the compositions of the 5 examples above were pre-heated to 60° C. before being mixed under vacuum (P<10 mbar) for 15 minutes. Each of the 5 compositions was then cast into steel molds pre-heated at 140° C. according to a Vacuum Casting Process and cured for 30 minutes.

In a first experiment the shaped articles were directly demolded and cooled down to room temperature under standard conditions. Samples were the taken and tested to determine whether the property profile was satisfactory without any post-curing. The properties at this time a of 30 minutes are reported in Table 2.

In a second experiment the shaped articles after demolding were post-cured at a temperature of 140° C. in an air circulating oven for up to 10 hours, then the same set of properties was measured to determine the extent of improvement of such properties, namely to determine the ultimate properties. Such ultimate properties at the post-curing time b of 10 hours are also reported in Table 2.

The results are shown in Table 2.

TABLE 2

| | | Comparison Ex. | | Example 1 | | Example 2 | | Example 3 | | Example 4 | |
|---|---|---|---|---|---|---|---|---|---|---|---|
| | | Property @ time | | Property @ time | | Property @ time | | Property @ time | | Property @ time | |
| | | a) 30′ | b) 10 h | a) 30′ | b) 10 h | a) 30′ | b) 10 h | a) 30′ | b) 10 h | a) 30′ | b) 10 h |
| Tg (° C.) | | 103.2 | 123.5 | 141.4 | 144.9 | 127.6 | 129.8 | 91.9 | 94.0 | 72.4 | 76.4 |
| Tensile | σᵣₘ (MPa) | 74.4 | 81.8 | 66.2 | 69.2 | 74.9 | 76 | 72.0 | 79.6 | 73.4 | 78.5 |
| Test | ε_{rb} (%) | 0.87 | 0.85 | 0.67 | 0.78 | 0.96 | 0.94 | 0.87 | 0.98 | 1.15 | 1.17 |
| | Eᵣ (GPa) | 11.12 | 11.31 | 11.0 | 10.9 | 9.78 | 9.72 | 11.0 | 10.8 | 9.87 | 9.72 |
| Flexural | σ_{fm} (MPa) | 100.3 | 127.1 | 102.3 | 106.7 | 107.2 | 108.2 | 129.7 | 134.5 | 126.8 | 129.5 |
| Properties | ε_{fm} (%) | 0.86 | 1.17 | 1.47 | 1.64 | 1.08 | 1.17 | 1.97 | 2.07 | 1.69 | 1.71 |
| | E_{f} (GPa) | 11.3 | 11.86 | 10.9 | 10.4 | 10.8 | 10.33 | 11.0 | 10.78 | 10.02 | 10.72 |
| Fracture | K_{lc} (MPam^{0.5}) | 2.12 | 2.07 | 1.95 | 1.93 | 2.10 | 2.09 | 2.40 | 2.49 | 2.70 | 2.71 |
| Toughness | G_{lc} (J/m²) | 380 | 343 | 288 | 294 | 419 | 404 | 450 | 474 | 674 | 686 |

### Discussion of Results

With the composition of example 1, which differs from the comparison example only for the replacement of a conventional benzyldimethylamine catalyst with a 1-substituted imidazole catalyst, a substantially higher Tg for both short curing time a and extended post-curing time b was obtained. Moreover, with the composition of ex.1 such improved Tg does not vary substantially when article is post-cured for an extended time. Taking the Tg developed after 10 hours of post-curing as the ultimate Tg (Tgu) that can be developed by each composition, it appears that whilst the composition of the comparison example is able to develop in 30′ a Tg which is 0.83 Tgu, the composition of example 1 is able to develop in 30′ a Tg which is 0.97 Tgu. This means that a satisfactory Tg (Tgs) fulfilling the relation 0.90 Tgu≦Tgs≦Tgu is developed in short time, thereby making unnecessary to extend the time of the fabrication process to allow the epoxy resin to develop its ultimate Tg (Tgu).

With the composition of example 2 (where bisphenol A is added as flexibilizer), the Tg is improved over the comparison example and a satisfactory Tg of 0.98 Tgu is developed at short post-curing time. Most of the properties are also improved, even at short post-curing time.

With the composition of example 3 (where PEG was used as flexibilizer instead of bisphenol A), a decrease in Tg was observed, compensated by a significant increase in flexural properties and fracture toughness. Again, a satisfactory Tgs of 0.97 Tgu was developed at short curing time.

With the composition of example 4 (where both bisphenol A and PEG were added), the Tg was significantly decreased with respect to the comparison example, due to high total flexibilizer content, amounting to about 35 phr of the polyepoxide. Nevertheless, a satisfactory Tgs of 0.94 Tgu was developed in a short post-curing time. Other properties of the epoxy resin composition of example 4 were substantially improved over the comparison example, in particular the fracture toughness, with respect to which the combination of an aromatic and aliphatic diol shows a synergistic effect at both short curing and extended post-curing times. With respect to the critical stress intensity factor K_{lc} after a short curing time, the composition of example 4 gives a value of 2.70 MPam^{0.5} which is a synergistic result over the values of 2.10 and 2.40 MPam^{0.5} of example 2 and 3, respectively. With respect to the critical energy release rate G_{lc} after a short curing time, the composition of example 4 gives a value of 674 J/m² which is a synergistic result over the values of 419 and 450 J/m² of example 2 and 3, respectively. The same is true for the corresponding values of such compositions after extended post-curing times.

It appears from the examples above that the compositions of example 2, 3 and 4, where a flexibilizer is present, are particularly performing in terms of crack resistance, the compositions of example 2 and 3 offering also a good balance with the Tg values and the composition of example 4 offering the best performance as to crack resistance.

As to the applicational field of the shaped articles obtained with the compositions and the process of the invention, it appears that the compositions of examples 2 and 3 are particularly suitable for the manufacturing of structural electrical components such as pole housing, tulips for medium and high voltage circuit breakers which may be exposed to high temperatures (hot-spot or long term), or generally to those applications where enhanced temperature resistance is necessary. The composition of example 4 is particularly suitable for the manufacturing of instruments and/or distribution transformers or articles where an increased crack resistance is required.

With respect to the process aspects of the invention, it is apparent that the possibility to develop a satisfactory Tg in a very short curing step, for example of 30 minutes, may render unnecessary to carry out such post-curing step on the demolded article, particularly when the temperature of the post-curing step is the same as that of the curing step carried out within the mold. Curing and post-curing can be consolidated, if desired and convenient, in just one step within the mold, whereby the shaped article is demolded and allowed to cool down to room temperature, resulting in a streamlining of the fabrication process.

The foregoing represent preferred embodiments of the invention. Variations and modifications will be apparent to persons skilled in the art, without departing from the inventive concepts disclosed herein. All such modifications and variations are intended to be within the scope of the invention, as defined in the following claims.

1. Curable epoxy resin composition comprising:
a polyepoxide
a anhydride hardener;
a 1-substituted imidazole as catalyst;
at least a diol;
a filler;
optionally additives or other ingredients.

2. Curable epoxy resin composition according to claim 1, wherein said polyepoxide is obtained by reacting an epihalohydrin with bisphenol A or with bisphenol F.

3. Curable epoxy resin composition according to claim 2, wherein said polyepoxide is the diglycidyl ether of bisphenol A (DGEBA) or of bisphenol F (DGEBF).

4. Curable epoxy resin composition according to claim 1 wherein said anhydride hardener is selected in the group consisting of methyltetrahydrophtalic anhydride; methyl-4-endomethylene tetrahydrophtalic anhydride; hexahydrophtalic anhydride; tetrahydrophtalic anhydride.

5. Curable epoxy resin composition according to claim 1, wherein said diol is selected in the group consisting of bisphenol A and a polyalkylenglycols.

6. Curable epoxy resin composition according to claim 5, wherein said polyalkylenglycol is polyethyleneglycol with a molecular weight Mw<1000.

7. Curable composition according to claim 5, wherein both bisphenol A and polyethyleneglycol with a molecular weight Mw<1000 are present in a weight ratio of from 80:20 to 20:80.

8. Curable composition according to claim 5 wherein said diol is present in an amount of from 5 to 50 phr of said polyepoxide.

9. Curable composition according to claim 8 wherein said diol is preferably present in an amount of from 10 to 40 phr of said polyepoxide

10. Curable composition according to claim 1, wherein said 1-substituted imidazole catalyst is 1-methylmidazole.

11. Curable composition according to claim 4, wherein said anhydride is present in amount of from 40 to 70 phr of the DGEBA or of the DGEBF.

12. Curable composition according to claim 11, wherein said anhydride is preferably present in an amount of from 50 to 65 phr of the DGEBA or of the DGEBF.

13. Curable composition according to claim 4, wherein said filler is silica.

14. Curable composition according to claim 13, wherein said filler is present in an amount of from 200 to 600 phr of said polyepoxide.

15. Curable composition according to claim 14, wherein said filler is present in an amount of from 250 to 500 phr of said polyepoxide.

16. Curable composition according to claim 15, wherein said filler is present in an amount of from 300 to 400 phr of said polyepoxide

17. Process for the fabrication of thermoset articles comprising the steps of:
a) pre heating a curable epoxy resin composition comprising a polyepoxide, an anhydride hardener; a 1-substituted imidazole catalyst; and optionally additives or other ingredients;
b) transferring such composition into a pre-heated mold;
c) curing said composition at a temperature and for a time sufficient to obtain a shaped article with an infusible three dimensional structure and a satisfactory Tg (Tgs) which fulfils the relation 0.90·Tgu≦Tgs≦Tgu, where Tgu is the ultimate Tg developable by the cured epoxy resin composition after a post curing step of 10 hours at a temperature of 140° C.

18. Process for the fabrication of thermoset articles according to claim 17, wherein said curable epoxy resin composition contains at least a diol selected in the group consisting of bisphenol A and a polyalkylenglycols.

19. Process for the fabrication of thermoset articles according to claim 18, wherein said polyepoxide of said curable epoxy resin composition is the diglycidyl ether of bisphenol A (DGEBA) or of bisphenol F (DGEBF).

20. Process for the fabrication of thermoset articles according to claim 17, wherein said anhydride hardener is selected in the group consisting of methyltetrahydrophtalic anhydride; methyl-4-endomethylene tetrahydrophtalic anhydride; hexahydrophtalic anhydride; tetrahydrophtalic anhydride.

21. Process for the fabrication of thermoset articles according to claim 20, wherein said anhydride hardener is present in amount of from 40 to 125 phr of the DGEBA or of the DGEBF.

22. Process for the fabrication of thermoset articles according to claim 21, wherein said anhydride hardener is present in amount of from 50 to 90 phr of the DGEBA or of the DGEBF.

23. Process for the fabrication of thermoset articles according to claim 18, wherein said diol is bisphenol A or polyethylene glycol or a mixture thereof.

24. Process for the fabrication of thermoset articles according to claim 23, wherein said diol is present in an amount of from 5 to 50 phr of said polyepoxide.

25. Process for the fabrication of thermoset articles according to claim 24, wherein said diol is preferably present in an amount of from 10 to 40 phr of said polyepoxide.

26. Process for the fabrication of thermoset articles according to claim 18, wherein said filler is silica.

27. Process for the fabrication of thermoset articles according to claim 26, wherein said filler is present in an amount of from 200 to 600 phr of said polyepoxide.

28. Process for the fabrication of thermoset articles according to claim 27, wherein said filler is present in an amount of from 250 to 500 phr of said polyepoxide.

29. Process for the fabrication of thermoset articles according to claim 28, wherein said filler is present in an amount of from 300 to 400 phr of said polyepoxide.

30. Process for the fabrication of thermoset articles according to claim 17, wherein said satisfactory Tg (Tgs) fulfils preferably the relation 0.94·Tgu≦Tgs≦Tgu.

31. Shaped thermoset articles obtainable by the process of claim 17.

32. Use of the shaped thermoset articles according to claim 30 for the manufacture of components or parts of electrical equipment.
